(19) United States
(12) Patent Application Publication
(10) Pub. No.: US 2014/0290248 A1
(43) Pub. Date: Oct. 2, 2014

(54) SOLAR HEAT RECEIVER, METHOD FOR ASSEMBLING SAME, AND SOLAR HEAT POWER GENERATION SYSTEM WITH SOLAR HEAT RECEIVER

(71) Applicant: MITSUBISHI HEAVY INDUSTRIES, LTD., Tokyo (JP)

(72) Inventors: Kazuta Kobayashi, Tokyo (JP); Masashi Tagawa, Tokyo (JP); Toshiyuki Osada, Tokyo (JP); Takeshi Okubo, Tokyo (JP); Akira Furutani, Tokyo (JP)

(73) Assignee: MITSHUBHISH HEAVY INDUSTRIES, LTD, Tokyo (JP)

(21) Appl. No.: 14/353,584

(22) PCT Filed: Dec. 21, 2012
(86) PCT No.: PCT/JP2012/083238

§ 371 Date: Apr. 23, 2014

(30) Foreign Application Priority Data
Dec. 22, 2011 (JP) 2011-281770

(51) Int. Cl. F03G 6/06; B21D 53/06; F24J 2/24

(52) U.S. Cl. CPC F03G 6/065; F24J 2/245; B21D 53/06
USPC 60/641.11; 126/663; 29/890.033

(57) ABSTRACT

A solar heat receiver includes a heat receiver tube support member that holds, with regular distances, longitudinally intermediate potions of a plurality of heat receiver tubes arranged in parallel and in plane. The support member extends to cross a longitudinal direction of the heat receiver tubes, and thus does not naturally move in the longitudinal direction of the heat receiver tubes, and when a predetermined force is applied in the longitudinal direction of the tubes, a position of the support member is maintained by a frictional force such that there is a slide between the heat receiver tube support member and the heat receiver tubes. Also, a plurality of heat receiver tube support members are provided in one solar heat receiver, and the heat receiver tubes are divided into a plurality of groups by the plurality of heat receiver tube support members.

### TECHNICAL FIELD

The present invention relates to a solar heat receiver that heats a heat medium using heat energy of concentrated solar energy, a method for assembling the same, and a solar heat power generation system including the solar heat receiver.

### BACKGROUND ART

As disclosed in PTL 1, as a clean power generation system using solar energy, a solar heat power generation system is known in which solar energy is reflected by a plurality of heliostats (reflectors) installed on the ground and concentrated on a solar heat receiver, and a fluid such as air, water, oil, molten salt, or the like flowing in the solar heat receiver is heated as a heat medium, heat energy of the heated heat medium is used to drive a turbine or the like, thereby generating power.

The solar heat receiver used in such a solar heat power generation system is configured in the form of a heat exchanger. Specifically, the solar heat receiver has a substantially square shape on front view and is configured so that multiple heat receiver tubes vertically extending are arranged in parallel and in plane, and the solar heat receiver has an upper header in which upper ends of the heat receiver tubes are connected, and a lower header in which lower ends of the heat receiver tubes are connected.

In the solar heat receiver, the heat medium flows from the lower header through the heat receiver tubes to the upper header. The heat medium is heated by the concentrated solar energy while passing through the heat receiver tubes, taken out of the heat receiver tubes from the upper header, and used as power generation energy.

Since a predetermined pitch is provided between each pair of the heat receiver tubes, a back reflector is installed on a back side of the solar heat receiver (opposite side from a solar energy incident side), and solar energy having passed through a gap between each pair of the heat receiver tubes is reflected by the back reflector to heat the heat receiver tubes from a back side, thereby increasing heat receiving performance.

### CITATION LIST

### Patent Literature

{PTL 1}

Japanese Unexamined Patent Application, Publication No. 2011-43127

### SUMMARY OF INVENTION

### Technical Problem

In the solar heat receiver configured as described above, multiple heat receiver tubes vertically extending are secured between the upper header and the lower header, and are heated to a high temperature of around 1000° C. Thus, long heat receiver tubes are curved and deformed by thermal expansion, which makes it difficult to maintain a proper mutual positional relationship. With significant curve and deformation of the heat receiver tubes, the heat receiver tubes come into contact with each other to generate an unnecessary stress load, which may reduce service life of the heat receiver tubes and also reduce heat receiving performance due to a shadow formed by overlap of the heat receiver tubes when viewed in an incident direction of the solar energy. On the other hand, if the heat receiver tubes are forced to be positioned using a positioning member or the like, the heat receiver tubes repeat thermal expansion and contraction, and thus metal fatigue may accumulate in the heat receiver tubes and the positioning member enough to break the heat receiver tubes and the positioning member.

The present invention is achieved in view of these circumstances, and has an object to provide a solar heat receiver, a method for assembling the same, and a solar heat power generation system including the solar heat receiver which allow a plurality of heat receiver tubes that constitute a solar heat receiver to be held with regular distances therebetween without any influence of thermal expansion, and can prevent reduction in heat receiving performance and increase service life, with a simple structure.

### Solution to Problem

In order to achieve the object, the present invention provides the following solutions.

Specifically, a first aspect of the present invention provides a solar heat receiver that is installed in a collecting casing having an aperture through which concentrated solar energy comes into the collecting casing, and that heats a heat medium using heat of the solar energy, comprising: a plurality of heat receiver tubes arranged in parallel and in plane; a first side header by which one ends of the plurality of heat receiver tubes are connected; a second side header by which the other ends of the plurality of heat receiver tubes are connected; a heat receiver tube support member that holds longitudinally intermediate portions of the plurality of heat receiver tubes with regular distances between the pipes, wherein the heat receiver tube support member extends to cross a longitudinal direction of the plurality of heat receiver tubes and holds to lock the heat receiver tubes with the regular distances so that the plurality of heat receiver tubes do not naturally move in the longitudinal direction thereof and a position of the heat receiver tube support member is maintained by a frictional force between the heat receiver tube support member and the heat receiver tubes, the frictional force allows a slide between the heat receiver tube support member and the heat receiver tubes when a predetermined or larger force is applied in the longitudinal direction of the heat receiver tubes.

With the above described configuration, the heat receiver tubes are held with regular distances by the heat receiver tube support member provided on the intermediate portions of the plurality of heat receiver tubes. This can prevent the heat receiver tubes from being curved and deformed by thermal expansion, and prevent generation of a stress load due to a contact between the heat receiver tubes, and a reduction in heat receiving performance due to a shadow formed by an overlap of the heat receiver tubes.

The heat receiver tube support member does not naturally move in the longitudinal direction of the heat receiver tubes, and when a predetermined force is applied in the longitudinal direction of the heat receiver tubes, the position of the heat receiver tube support member is maintained by a frictional force such that there is a slide between the heat receiver tube support member and the heat receiver tubes. Thus, for example, if the heat receiver tubes expand and contract due to thermal expansion, the heat receiver tube and the heat receiver tube support member can slide and relatively move. Thus, even if the heat receiver tubes repeat thermal expansion and contraction, metal fatigue may not accumulate in the heat receiver tubes and the heat receiver tube support member, thereby increasing service life of the solar heat receiver.

The heat receiver tube support member is installed on the longitudinally intermediate portions of the heat receiver tubes, and these positions have the largest amount of deformation of the heat receiver tubes. Thus, a large frictional force is generated between the heat receiver tube support member and the heat receiver tubes. This allows the heat receiver tube support member to be secured in place.

A second aspect of the present invention provides the solar heat receiver according to the first aspect, wherein the heat receiver tube support member is made of the same material as the heat receiver tube.

With the above described configuration, the heat receiver tube and the heat receiver tube support member made of the same material have the same coefficient of thermal expansion and the same amount of thermal expansion. This can reduce an amount of relative movement between the heat receiver tube and the heat receiver tube support member due to thermal expansion, and more effectively prevent deformation of the heat receiver tube due to thermal expansion.

A third aspect of the present invention provides the solar heat receiver according to the first or second aspect, wherein two or more of the heat receiver tube support members are provided in one solar heat receiver, the heat receiver tubes are divided into a plurality of groups by the plurality of heat receiver tube support members and locked, and an end of each of the heat receiver tube support members of the plurality of groups hold at least one of the heat receiver tubes located at ends of adjacent groups.

With the above described configuration, the number of heat receiver tubes held by one heat receiver tube support member is reduced as compared to a case where all the heat receiver tubes are continuously held by one heat receiver tube support member. Thus, even if the heat receiver tubes are deformed by thermal expansion, the degree of stress applied to the heat receiver tube support member due to accumulation of the deformation is reduced. This can prevent breakage of the heat receiver tube support member, and increase service life of the solar heat receiver. Further, the ends of the heat receiver tube support members hold the heat receiver tube located at the ends of the adjacent heat receiver tube groups, thereby maintaining a proper distance between the heat receiver tube groups.

A fourth aspect of the present invention provides the solar heat receiver according to any one of the first to third aspects, wherein the heat receiver tube support member includes a corrugated strip with alternately continuous peaks and valleys when viewed in the longitudinal direction of the heat receiver tubes, and a flat strip joined in contact with the valleys of the corrugated strip, the heat receiver tubes are held between the peaks of the corrugated strip and the flat strip, and the corrugated strip is placed on a solar energy incident side.

With the above described configuration, the heat receiver tubes can be held relatively movably by a simple configuration. Also, workability can be improved in a case where the heat receiver tube support member is mounted to the heat receiver tubes in a place where the solar heat receiver is installed (outside). Further, in a case where the plurality of heat receiver tubes are arranged, for example, in an arcuate shape with a recess on the solar energy incident side, a reaction force of the heat receiver tube support member is reduced, thereby allowing the heat receiver tubes to be precisely arranged and supported along a curvature of the arc.

A fifth aspect of the present invention provides a method for assembling a solar heat receiver, the solar heat receiver in which heat receiver tubes are arranged so as to vertically extend and form an arcuate shape with a recess on a solar energy incident side in plan view, and intermediate portions of the heat receiver tubes are held by the heat receiver tube support member configured in accordance with claim 4, the method comprising the steps of: arranging and temporarily fastening the heat receiver tubes in an arcuate shape using a temporary fastening jig; laying a corrugated strip on the heat receiver tubes from the solar energy incident side; making a flat strip become in contact with the valleys of the corrugated strip from an opposite side from the solar energy incident side; joining the valleys and the flat strip; and removing the temporary fastening jig.

According to the method for assembling the solar heat receiver, with the plurality of heat receiver tubes being arranged in an arcuate shape by the temporary fastening jig, the corrugated strip and the flat strip are mounted to the heat receiver tubes, and the strips are joined by spot welding, thereby finishing the heat receiver tube support member. Thus, the curved arrangement shape is maintained by the heat receiver tube support member even after the temporary fastening jig is removed. This can reduce the probability of deformation of the heat receiver tube support member into an irregular shape when heated, prevent thermal stress or metal fatigue in the heat receiver tubes and the heat receiver tube support member, and increase service life of the solar heat receiver. For joining the valleys of the corrugated strip and the flat strip, a simple joining means can be used such as spot welding or rivetting that can be performed in high places or in a lifted condition.

A sixth aspect of the present invention provides a solar heat power generation system including: a solar heat receiver according to any one of claims 1 to 4; a heliostat that concentrates and leads solar energy to the solar heat receiver; a turbine device that is rotated by a hot heat medium led out from the solar heat receiver; and a power generator rotated by the turbine device.

According to the solar heat power generation system with the above described configuration, the plurality of heat receiver tubes that constitute the solar heat receiver are held by the heat receiver tube support member, and thus held with regular distances without any influence of the thermal expansion, thereby preventing a reduction in heat receiving performance and increasing service life. Thus, the heat medium can be stably supplied to the turbine device to continue power generation, thereby improving reliability of the entire solar heat power generation system.

### Advantageous Effects of Invention

As described above, the solar heat receiver, the method for assembling the same, and the solar heat power generation system including the solar heat receiver according to the present invention allow the plurality of heat receiver tubes that constitute the solar heat receiver to be held with regular distances without any influence of thermal expansion, and can prevent a reduction in heat receiving performance and increase service life, with a simple structure.

### BRIEF DESCRIPTION OF DRAWINGS

FIG. 1 is a schematic diagram of a solar heat power generation system according to an embodiment of the present invention.

FIG. 2 is a front view of the solar heat receiver.

FIG. 3 is a perspective view showing heat receiver tubes and heat receiver tube support members.

FIG. 4 is a cross sectional view taken along the line IV-IV in FIG. 3.

FIG. 5 is a plan view showing the heat receiver tubes and a temporary fastening jig before assembled.

FIG. 6 is a plan view showing the heat receiver tubes being temporarily fastened by the assembled temporary fastening jig.

FIG. 7 is a plan view showing the heat receiver tube support member being assembled to the heat receiver tubes from the state in FIG. 6.

### DESCRIPTION OF EMBODIMENTS

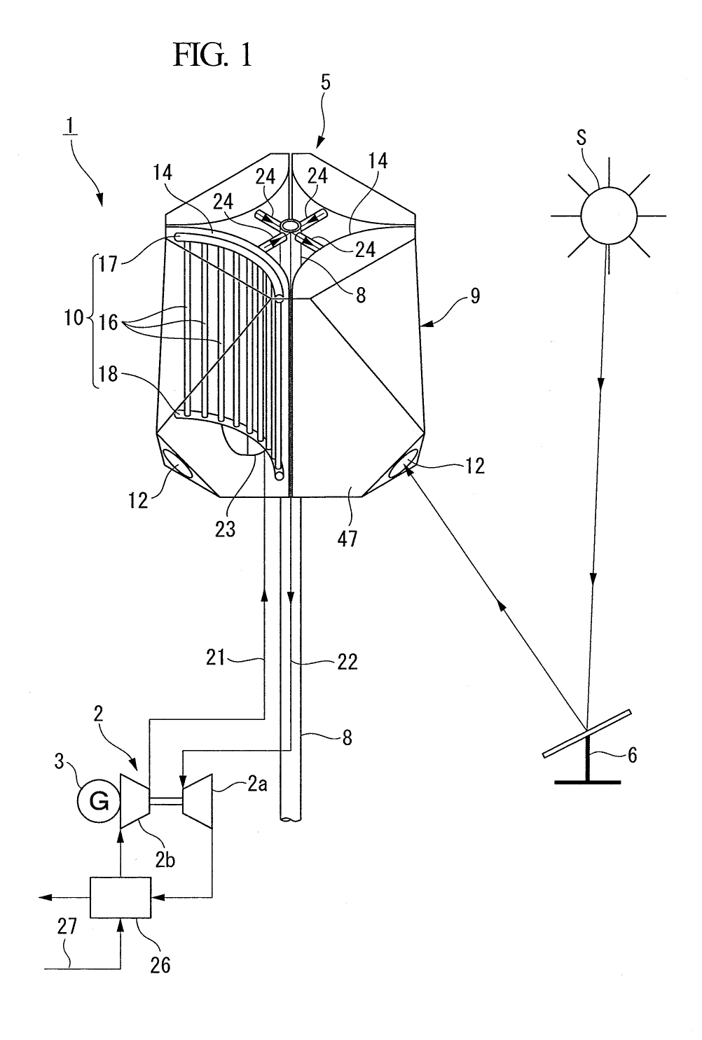

Now, with reference to FIGS. 1 to 7, one of a plurality of embodiments of the present invention will be described below.

FIG. 1 is a schematic diagram of a solar heat power generation system according to an embodiment of the present invention. The solar heat power generation system 1 is a system in which, for example, air is used as a heat medium, heat of the sun S is collected to heat the air to about 900° C. to 1000° C. and thermally expand the air, a turbine device 2 is rotated by heat energy of the thermally expanded air to drive a power generator 3 attached to the turbine device 2, and generate power.

The solar heat power generation system 1 includes a tower-like solar heat receiving device 5, and multiple heliostats 6 (reflectors) placed around the solar heat receiving device 5. In the solar heat receiving device 5, four collecting casings 9 are mounted at a high position of a tower 8 standing on the ground so that the four collecting casings face four directions, respectively, and each collecting casing 9 includes therein a solar heat receiver 10 according to the present invention. Each collecting casing 9 has a circular or oval aperture 12 that opens toward the heliostats 6, and solar light collected by the plurality of heliostats 6 enters the collecting casing 9 through the aperture 12 and is led to the solar heat receiver 10.

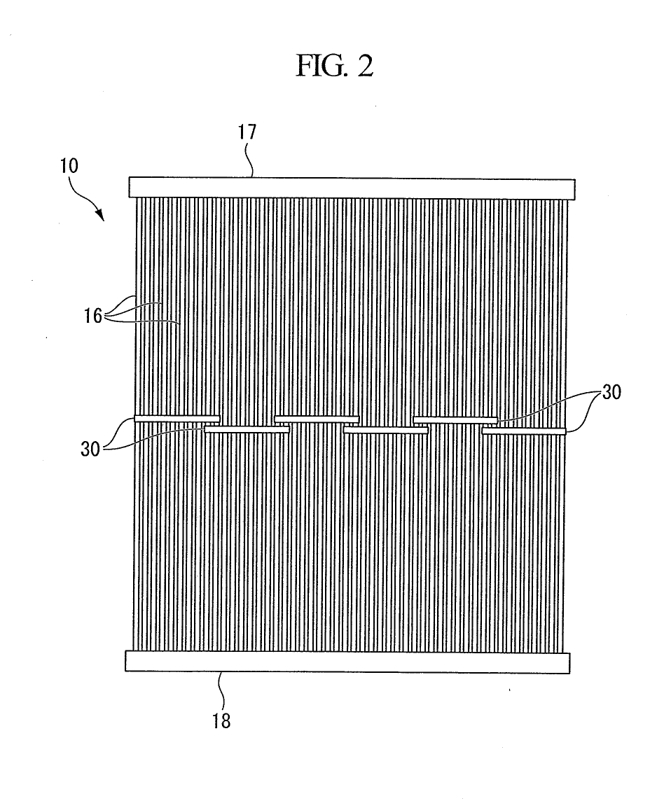

A back plate 14 located on an opposite side from the aperture 12 in each collecting casing 9 is curved into a cylindrical surface shape with a recess on the side of the aperture 12 in plan view, and an inner surface of the back plate 14 is a mirror surface. Inner surfaces of all other wall surfaces that constitute the collecting casing 9 are also mirror surfaces. Also as shown in FIG. 2, the four solar heat receivers 10 are each formed in the form of a heat exchanger including multiple heat receiver tubes 16 vertically extending, an upper header 17 (one side header) in which upper ends of the heat receiver tubes 16 are connected, and a lower header 18 (the other side header) in which lower ends of the heat receiver tubes 16 are connected.

A heat medium rising pipe 21 and a heat medium falling pipe 22 are provided in the tower 8, the heat medium rising pipe 21 is connected via a distribution pipe 23 to the lower header 18 of each solar heat receiver 10, and the heat medium falling pipe 22 is connected via a gathering pipe 24 to the upper header 17 of each solar heat receiver 10. The other end of the heat medium falling pipe 22 is connected to a drive turbine 2a of the turbine device 2, and the other end of the heat medium rising pipe 21 is connected to a compression turbine 2b of the turbine device 2. The drive turbine 2a and the compression turbine 2b are coaxially provided and integrally rotated. An air superheater 26 is installed near the turbine device 2 so that air discharged from the drive turbine 2a passes through the air superheater 26. An intake pipe 27 that takes air is connected to the compression turbine 2b of the turbine device 2, and the intake pipe 27 passes through an inside of the air superheater 26.

The plurality of heliostats 6 are automatically controlled by a control device (not shown) so as to change their angles or orientations in accordance with movement of the sun S. During daylight hours, most heliostats 6 always collect light of the sun S, and the collected solar energy is led through the aperture 12 to the solar heat receiver 10 in the collecting casing 9. Thus, the solar heat receiver 10 is heated, and air in the heat receiver tubes 16 in the solar heat receiver 10 is increased in temperature to about 900° C. to 1000° C. and thermally expanded. The thermally expanded hot air is led from the upper header 17 in the solar heat receiver 10 through the gathering pipe 24, flows to the heat medium falling pipe 22 and is supplied to the drive turbine 2a of the turbine device 2, rotates the drive turbine 2a, and then passes through the air superheater 26. The air having passed through the drive turbine 2a is reduced in temperature to about 400° C., but can still heat the air superheater 26.

As described above, when the heated air rotationally drives the drive turbine 2a, the power generator 3 provided coaxially with the drive turbine 2a or on a different axis via a gear is driven to generate power. The compression turbine 2b provided coaxially with the drive turbine 2a is also rotated to suck outside air through the intake pipe 27. When passing through the air superheater 26, the outside air is heated by heat exchange with air having passed through the drive turbine 2a and at a temperature of about 400° C., then compressed by the compression turbine 2b, and supplied through the heat medium rising pipe 21 and the distribution pipe 23 to the lower header 18 in each solar heat receiver 10. The air is heated by the solar heat while flowing from the lower header 18 through heat receiver tubes 16 to the upper header 17, and is supplied to the drive turbine 2a of the turbine device 2 to drive the power generator 3 and the compression turbine 2b as described above.

Next, configurations of essential portions of the present invention will be described.

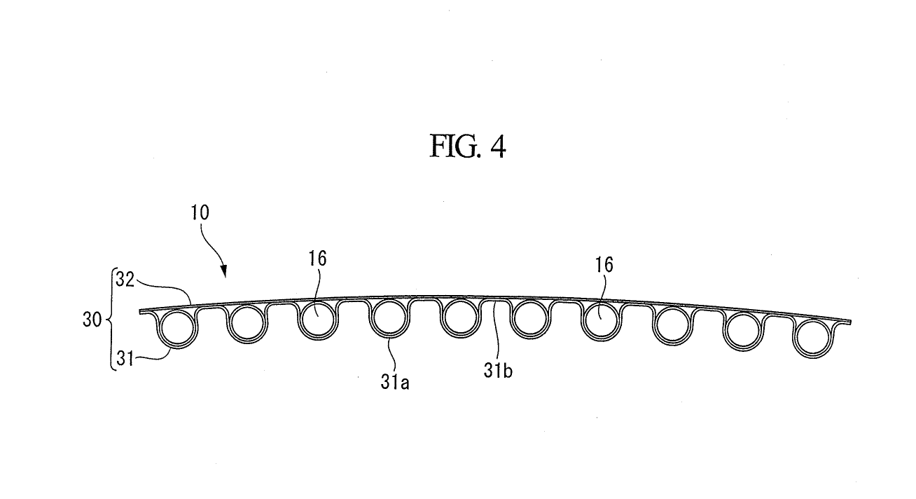

As shown in FIGS. 2 to 4, the heat receiver tubes 16 vertically extending to connect the upper header 17 and the lower header 18 in the solar heat receiver 10 are arranged in parallel with each other and in plane. As shown in FIG. 1, the upper header 17 and the lower header 18 are curved to form a recess on a solar energy incident side (a side of the aperture 12 in the collecting casing 9) in plan view, and along therewith, the heat receiver tubes 16 are also arranged in an arcuate shape to form a recess on the solar energy incident side in plan view (see FIG. 4). Longitudinally intermediate portions of the heat receiver tubes 16 are held with regular distances by heat receiver tube support members 30. In FIG. 2, fifty heat receiver tubes 16 are arranged, but this number is an example, and more or less than fifty heat receiver tubes 16 may be arranged.

As shown in FIG. 2, the heat receiver tube support member 30 is a substantially strip-like member formed to cross the longitudinal direction of the heat receiver tubes 16, that is, to horizontally extend, and hold to lock the heat receiver tubes 16 with regular distances. A plurality of, for example, six heat receiver tube support members 30 are provided in one solar heat receiver 10, and the fifty heat receiver tubes 16 are divided into six groups and locked by the six heat receiver tube support members 30. Here, for example, one heat receiver tube support member 30 holds ten heat receiver tubes 16.

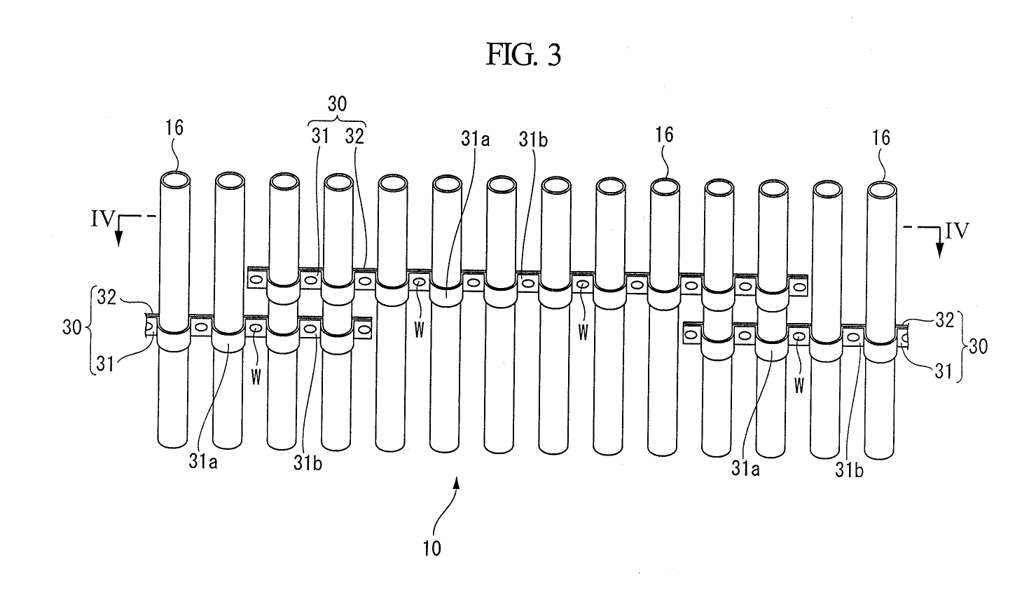

Also as shown in FIG. 3, ends of the heat receiver tube support members 30 of the six groups of the heat receiver tubes 16 hold two heat receiver tubes 16 located at ends of adjacent groups. Thus, the heat receiver tube support members 30 are arranged in a vertically staggered manner in front view (see FIG. 2). A position (height) in which the heat receiver tube support members 30 are installed is within a range of about 15% of the entire length of the heat receiver tubes 16 upward and downward from a middle along the length of the heat receiver tubes 16.

As shown in FIGS. 3 and 4, the heat receiver tube support member 30 includes a corrugated strip 31 with alternately continuous peaks 31a and valleys 31b when viewed in the longitudinal direction of the heat receiver tube 16, and a flat strip 32 joined in contact with the valleys 31b of the corrugated strip 31. The heat receiver tubes 16 are held between the peaks 31a of the corrugated strip 31 and the flat strip 32, and a contact portion W (see FIG. 3) between the valley 31b of the corrugated strip 31 and the flat strip 32 is secured by, for example, spot welding, rivetting, bolting, or the like. The corrugated strip 31 is placed on a solar energy incident side, that is, a front side of the solar heat receiver 10, and the flat strip 32 is placed on a rear side of the solar heat receiver 10. The heat receiver tube support members 30 are made of the same material as the heat receiver tube 16, and may be made of, for example, SUS304 material having high heat resistance or HASTELLOY (registered trademark for a nickel-base alloy manufactured by Haynes International, Inc.).

The heat receiver tube support member 30 is not fixedly secured to the heat receiver tube 16 using a specific fastener, but a position of the heat receiver tube support member 30 is maintained only by a frictional force generated by a part of the ten heat receiver tubes 16. The frictional force is set such that the heat receiver tube support member 30 does not naturally move to fall under its own weight or some vibration, and that when a predetermined or larger force is applied in the longitudinal direction of the heat receiver tube 16, there is a slide between the heat receiver tube support member 30 and the heat receiver tube 16. As an example, the heat receiver tube support member 30 is held by frictional forces of two heat receiver tubes 16 at the middle, and the other eight heat receiver tubes 16 on the left and right are loosely held and locked with spaces as allowances. The heat receiver tube support member 30 may be held by frictional forces of two heat receiver tubes 16 at each of left and right ends.

With the solar heat receiver 10 configured as described above, the plurality of heat receiver tube support members 30 are provided in the intermediate portions of the multiple heat receiver tubes 16, and the heat receiver tube support members 30 hold the heat receiver tubes 16 with regular distances. Thus, even if the heat receiver tubes 16 are thermally expanded by solar heat, the heat receiver tubes 16 are prevented from being curve and deformed. This can prevent generation of a stress load due to a contact between the heat receiver tubes 16, and a reduction in heat receiving performance due to a shadow formed by an overlap of the heat receiver tubes 16.

The heat receiver tubes 16 are loosely held and locked with spaces as allowances. This can prevent adhesion between the heat receiver tube support member 30 and the heat receiver tubes 16 due to heat even in long-term operation.

The heat receiver tube support member 30 does not naturally move in the longitudinal direction of the heat receiver tubes 16, and when a predetermined or larger force is applied in the longitudinal direction of the heat receiver tubes 16, the position of the heat receiver tube support member 30 is maintained by a frictional force such that there is a slide between the heat receiver tube support member 30 and the heat receiver tubes 16. Thus, for example, if the heat receiver tubes 16 expand and contract due to thermal expansion, the heat receiver tubes 16 and the heat receiver tube support member 30 can slide and relatively move. Thus, even if the heat receiver tubes 16 repeat thermal expansion and contraction, metal fatigue may not accumulate in the heat receiver tubes 16 and the heat receiver tube support member 30, thereby increasing service life of the solar heat receiver 10.

The heat receiver tube support member 30 is installed in the longitudinally intermediate portions of the heat receiver tubes 16, and these positions are supposed to have the largest amount of deformation of the heat receiver tubes 16. Thus, a large frictional force is naturally generated between the heat receiver tube support member 30 and the heat receiver tubes 16. This allows the heat receiver tube support member 30 to be secured at a predetermined position.

The heat receiver tube support member 30 is made of the same material as the heat receiver tubes 16, and thus the heat receiver tube support member 30 and the heat receiver tubes 16 have the same coefficient of thermal expansion and substantially the same amount of thermal expansion. This can reduce an amount of relative movement between the heat receiver tubes 16 and the heat receiver tube support member 30 due to thermal expansion, thereby more effectively preventing deformation of the heat receiver tubes 16 due to thermal expansion. Further, the heat receiver tubes 16 and the heat receiver tube support member 30 in contact with each other are made of the same material, thereby preventing occurrence of a potential difference and eliminating concern about electric corrosion.

Further, the six heat receiver tube support members 30 are provided in one solar heat receiver 10, and the fifty heat receiver tubes 16 are divided into six groups and locked by the six heat receiver tube support members 30. Thus, the number of heat receiver tubes 16 held by one heat receiver tube support member 30 is reduced to 10 as compared to a case where, for example, fifty heat receiver tubes 16 are continuously held by one heat receiver tube support member. Thus, even if the heat receiver tubes 16 are deformed by thermal expansion, the degree of stress applied to the heat receiver tube support member 30 due to accumulation of the deformation is reduced. This can prevent breakage of the heat receiver tube support member 30, and increase service life of the solar heat receiver 10.

Further, at the ends of the heat receiver tube support members 30 of the six groups of the heat receiver tubes 16 held by the six, the heat receiver tube support members 30 hold two heat receiver tubes 16 located at the ends of adjacent groups. This can maintain a proper distance between the groups of the heat receiver tubes 16.

Further, for lateral expansion by the heat receiver tube support member 30, the heat receiver tube support member 30 loosely hold and lock only about ten heat receiver tubes 16, and thus the heat receiver tubes 16 are not laterally expanded by the heat receiver tube support member 30 unnecessarily.

Also, the heat receiver tube support member 30 includes the corrugated strip 31 with the alternately continuous peaks 31a and valleys 31b when viewed in the longitudinal direction of the heat receiver tubes 16, and the flat strip 32 joined in contact with the valleys 31b of the corrugated strip 31, and the heat receiver tubes 16 are held between the peaks 31a of the corrugated strip 31 and the flat strip 32. Thus, the heat receiver tubes 16 can be movably held with each other by a simple configuration. Also, even in a case where the heat receiver tube support member 30 is mounted on the heat receiver tubes 16 at a construction site of the solar heat receiver 10 (outside), the corrugated strip 31 and the flat strip 32 can be joined with good workability to assemble the heat receiver tube support member 30.

Further, the corrugated strip 31 that constitutes the heat receiver tube support member 30 is placed on the solar energy incident side of the solar heat receiver 10, and the flat strip 32 is placed on the back plate 14 side of the solar heat receiver 10. Thus, as in this embodiment, when the heat receiver tubes 16 are arranged in the arcuate shape with a recess on the solar energy incident side, a reaction force (force that acts to return to a straight line) of the heat receiver tube support member 30 is reduced, thereby allowing the heat receiver tubes 16 to be precisely arranged and supported along a curvature of the arc. Further, the thin flat strip 32 can be easily inserted into a narrow space between the solar heat receiver 10 and the back plate 14 installed behind the solar heat receiver 10, thereby facilitating assembly of the heat receiver tube support member 30.

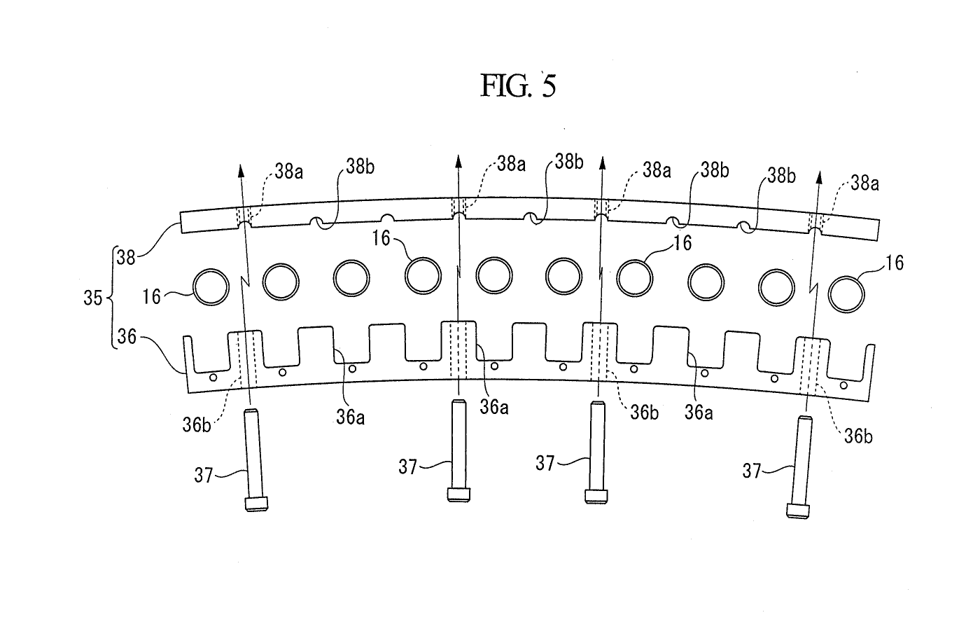

Next, with reference to FIGS. 5 to 7, a method for assembling the heat receiver tube support member 30 to the heat receiver tubes 16 will be described. The heat receiver tube support member 30 is assembled using a special temporary fastening jig 35. The temporary fastening jig 35 includes a front fastener 36 that is curved into an arch shape in plan view and mounted from a front side of the solar heat receiver 10, and a rear fastener 38 that is mounted from a rear side of the solar heat receiver 10, and coupled to the front fastener 36 via the heat receiver tubes 16 by four bolts 37. The front fastener 36 has ten notches 36a with regular distances, in which the heat receiver tubes 16 closely fit, and bolt insertion holes 36b through which the bolts 37 are passed. The rear fastener 38 has female screw holes 38a in which the bolts 37 are fit, and recessed portions 38b used in welding described later.

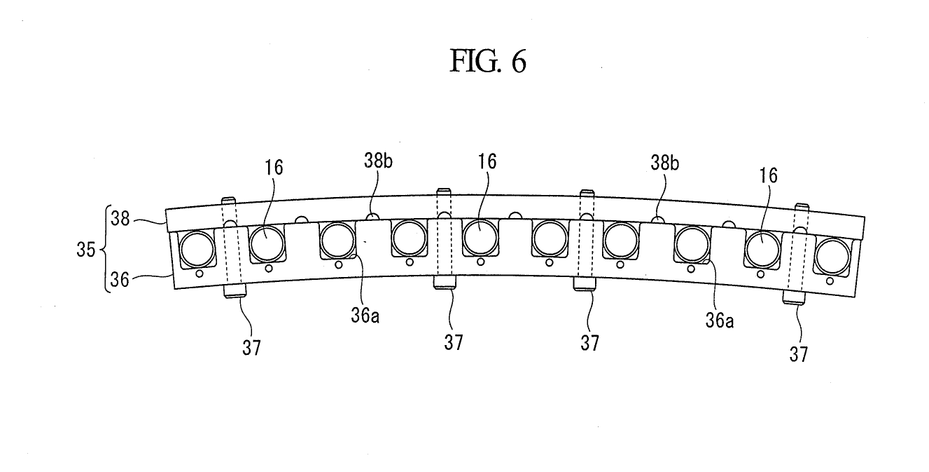

First, as shown in FIGS. 5 and 6, the temporary fastening jig 35 is mounted to the heat receiver tubes 16, and the heat receiver tubes 16 are arranged in an arcuate shape and temporarily secured using the temporary fastening jig 35. When the rear fastener 38 is coupled to the front fastener 36 of the temporary fastening jig 35 by the four bolts 37, the entire temporary fastening jig 35 is positioned on the heat receiver tubes 16 with a light frictional force. The temporary fastening jig 35 is mounted to arrange and secure the ten heat receiver tubes 16 in an arcuate shape along curved shapes of the upper header 17 and the lower header 18.

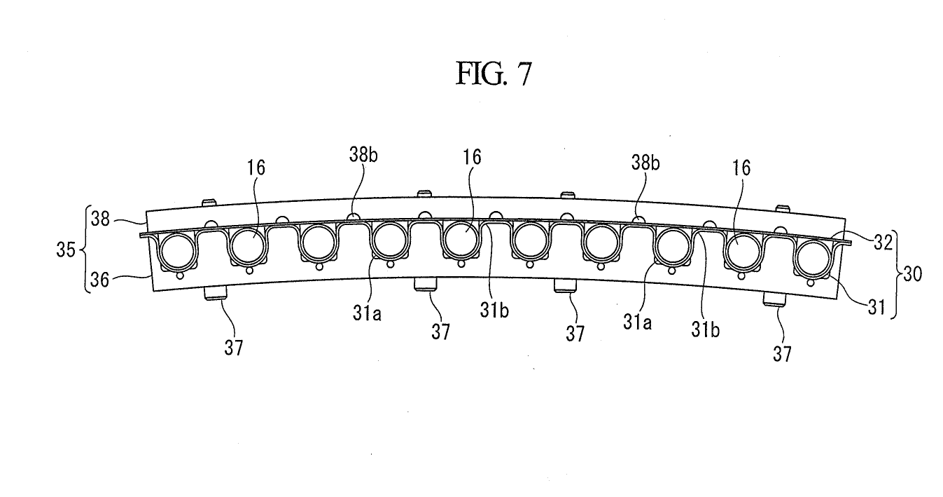

Next, as shown in FIG. 7, the corrugated strip 31 of the heat receiver tube support member 30 is laid on the heat receiver tubes 16 from the front side of the solar heat receiver 10. At this time, the heat receiver tubes 16 are fitted into the peaks 31a of the corrugated strip 31 so that the corrugated strip 31 is placed on an upper surface of the front fastener 36. Then, the flat strip 32 is applied to the valleys 31b of the corrugated strip 31 from the rear side of the solar heat receiver 10, and then the valleys 31b and the flat strip 32 are joined by spot welding or the like. A tip of a spot welder is inserted into the recessed portion 38b of the rear fastener 38 for welding. After the welding is completed, the temporary fastening jig 35 is removed from the heat receiver tubes 16. Thus, as shown in FIG. 4, the heat receiver tube support member 30 is attached to the heat receiver tubes 16 arranged in an arcuate shape.

According to the above described assembling method, with the plurality of heat receiver tubes 16 being arranged in the arcuate shape by the temporary fastening jig 35, the corrugated strip 31 and the flat strip 32 are mounted to the heat receiver tubes 16, and joined by spot welding or the like, thereby completing the heat receiver tube support member 30. Thus, an arrangement shape with the curved heat receiver tube support member 30 can be maintained even after the temporary fastening jig 35 is removed. This can reduce the probability of deformation of the heat receiver tube support member 30 in an irregular shape when heated, prevent thermal stress or metal fatigue in the heat receiver tubes 16 and the heat receiver tube support member 30, and increase service life of the solar heat receiver 10. For joining the valleys 31b of the corrugated strip 31 and the flat strip 32, a simple joining means can be used such as spot welding or rivetting that can be performed in high places or in a lifted condition. Thus, joining can be easily performed even in an installation site of the solar heat power generation system 1, that is, in a high place on top of the tower 8.

According to the solar heat power generation system 1 including the solar heat receiver 10 configured as described above, the plurality of heat receiver tubes 16 that constitute the solar heat receiver 10 are held by the heat receiver tube support member 30, and thus held with regular distances without any influence of the thermal expansion. This prevents a reduction in heat receiving performance and increases service life of the solar heat receiver 10. Thus, the heat medium can be stably supplied to the turbine device 2 to continue power generation, thereby improving reliability of the entire solar heat power generation system 1.

The present invention is not limited to the configuration of the above described embodiment, but changes or improvements may be made without departing from the gist of the present invention, and embodiments with such changes or improvements fall within the scope of present invention.

For example, in the above described embodiment, the tower-type solar heat receiving device 5 is illustrated in which the solar heat receiver 10 is housed in the collecting casing 9 installed on top of the tower 8, and the multiple heliostats 6 placed around the tower 8 collect solar energy and project the light on the collecting casing 9. The present invention may be applied to, not limited to the tower-type, for example, a beam-down-type solar heat receiving device in which solar energy is reflected above a middle portion of a system by a heliostat, and the reflected light is collected by a receiver (heat receiving portion) installed below using a large reflector called a center reflector.

As the heat medium to be supplied to the solar heat receiver 10, not limited to air, various media such as water, oil, or molten salt may be conceivable.

### Reference Signs List

1 solar heat power generation system

2 turbine device

3 power generator

5 solar heat receiving device

6 heliostat

8 tower

9 collecting casing

10 solar heat receiver

12 aperture

16 heat receiver tube

17 upper header (one header)

18 lower header (the other header)

30 heat receiver tube support member

31 corrugated strip

31a peak

31b valley

32 flat strip

35 temporary fastening jig

1. A solar heat receiver that is installed in a collecting casing having an aperture through which concentrated solar energy comes into the collecting casing, and that heats a heat medium using heat of the solar energy, comprising:
a plurality of heat receiver tubes arranged in parallel and in plane;
a first side header by which one ends of the plurality of heat receiver tubes are connected;
a second side header by which the other ends of the plurality of heat receiver tubes are connected;
a heat receiver tube support member that holds longitudinally intermediate portions of the plurality of heat receiver tubes with regular distances between the tubes,
wherein the heat receiver tube support member extends to cross a longitudinal direction of the plurality of heat receiver tubes and holds to lock the heat receiver tubes with the regular distances so that the plurality of heat receiver tubes do not naturally move in the longitudinal direction thereof and a position of the heat receiver tube support member is maintained by a frictional force between the heat receiver tube support member and the heat receiver tubes, the frictional force allows a slide between the heat receiver tube support member and the heat receiver tubes when a predetermined or larger force is applied in the longitudinal direction of the heat receiver tubes.

2. The solar heat receiver according to claim 1, wherein the heat receiver tube support member is made of the same material as the heat receiver tube.

3. The solar heat receiver according to claim 1, wherein two or more of the heat receiver tube support members are provided in one solar heat receiver, the heat receiver tubes are divided into a plurality of groups by the plurality of heat receiver tube support members and locked, and an end of each of the heat receiver tube support members of the plurality of groups hold at least one of the heat receiver tubes located at ends of adjacent groups.

4. The solar heat receiver according to claim 1, wherein the heat receiver tube support member includes a corrugated strip with alternately continuous peaks and valleys when viewed in the longitudinal direction of the heat receiver tubes, and a flat strip joined in contact with the valleys of the corrugated strip, the heat receiver tubes are held between the peaks of the corrugated strip and the flat strip, and the corrugated strip is placed on a solar energy incident side.

5. A method for assembling a solar heat receiver, the solar heat receiver in which heat receiver tubes are arranged so as to vertically extend and form an arcuate shape with a recess on a solar energy incident side in plan view, and intermediate portions of the heat receiver tubes are held by the heat receiver tube support member configured in accordance with claim 4, the method comprising the steps of:
arranging and temporarily fastening the heat receiver tubes in an arcuate shape using a temporary fastening jig;
laying a corrugated strip on the heat receiver tubes from the solar energy incident side;
making a flat strip become in contact with the valleys of the corrugated strip from an opposite side from the solar energy incident side;
joining the valleys and the flat strip; and
removing the temporary fastening jig.

6. A solar heat power generation system comprising:
a solar heat receiver according to claim 1;
a heliostat that concentrates and leads solar energy to the solar heat receiver;
a turbine device that is rotated by a hot heat medium led out from the solar heat receiver; and
a power generator rotated by the turbine device.
